(19) United States
(12) Patent Application Publication
(10) Pub. No.: US 2026/0311123 A1
(43) Pub. Date: Oct. 8, 2026

(54) PERCEPTION BASED VIRTUAL GALLEY MANAGEMENT SYSTEM

(71) Applicant: B/E AEROSPACE, INC., Winston-Salem, NC (US)

(72) Inventors: Bryce C. Baker, Raymore, MO (US); Fangzhong Guo, Seattle, WA (US); Lily Liu, Sammamish, WA (US); Adwait Arun Trikanad, Vancouver, WA (US); Andrew Radlbeck, South Glastonbury, CT (US); Jefferey M. McKee, Duvall, WA (US); Travis John Vaninetti, Bothell, WA (US); Lorenzo David Kearns, Seattle, WA (US)

(73) Assignee: B/E AEROSPACE, INC., Winston-Salem, NC (US)

(21) Appl. No.: 19/633,603

(22) Filed: Mar. 30, 2026

Related U.S. Application Data
(60) Provisional application No. 63/782,996, filed on Apr. 3, 2025.

(51) Int. Cl. G06Q 10/087; B64D 11/04

(52) U.S. Cl. CPC G06Q 10/0877; B64D 11/04

(57) ABSTRACT

A perception based virtual galley management system including at least one edge controller, at least one leaf controller communicatively coupled to the at least one edge controller, and at least one sensor communicatively coupled to the at least one leaf controller. The at least one edge controller is configured to receive and process sensor data from the at least one sensor, via the at least one leaf controller, to track a plurality of items as they move in to or out of a standard unit within a galley of an aircraft.

### CROSS-REFERENCE TO RELATED APPLICATIONS

This application claims priority to and the benefit of, U.S. Provisional Application No. 63/782,996, filed Apr. 3, 2025, and entitled “PERCEPTION BASED VIRTUAL GALLEY MANAGEMENT SYSTEM,” which is incorporated by reference herein in its entirety for all purposes.

### FIELD

The present disclosure generally relates to aircraft galleys, and more specifically, to a perception based virtual galley management system.

### BACKGROUND

Passenger aircrafts, such as commercial airplanes, include a passenger cabin with passenger seats and typically one or more galleys that store food and beverages on the aircraft. Food and beverages are typically stored in galley cabinets and galley carts, which are stowed in galley compartments and may be removed by the crew to provide passenger service. Galleys may be located at different locations in the aircraft, e.g., in the area between the cockpit and the first row or passenger seats, at the back of the aircraft behind the last row of passenger seats or, for large aircraft, at various locations between aisles/rows of seats.

### SUMMARY

Disclosed herein is a perception based virtual galley management system including at least one edge controller, at least one leaf controller communicatively coupled to the at least one edge controller, and at least one sensor communicatively coupled to the at least one leaf controller. The at least one edge controller is configured to receive and process sensor data from the at least one sensor, via the at least one leaf controller, to track a plurality of items as they move in to or out of a standard unit within a galley of an aircraft.

In various embodiments, the perception based virtual galley management system further includes one or more digital panels, the one or more digital panels communicatively coupled to the at least one edge controller. In various embodiments, the one or more digital panels are each configured with a user interface (UI) for interfacing with the at least one edge controller to perform operations associated with the plurality of items within the galley.

In various embodiments, the perception based virtual galley management system further includes a set of standard units and a set of indicator lights. In various embodiments, the standard unit is one of the set of standard units. In various embodiments, each indicator light in the set of standard units associated with a respective standard unit in the set of standard units. In various embodiments, responsive to a request from a crew member via one of the one or more digital panels to locate an item of the plurality of items in one of the set of standard units, the at least one edge controller is configured to identify the standard unit including the item via the indicator light associated with the standard unit.

In various embodiments, the perception based virtual galley management system further includes one or more portable crew devices, the one or more portable crew devices communicatively coupled to the at least one edge controller. In various embodiments, the one or more portable crew devices are each configured with a user interface (UI) for interfacing with the at least one edge controller to perform operations associated with the plurality of items within the galley.

In various embodiments, the perception based virtual galley management system further includes one or more portable passenger devices. In various embodiments, the one or more portable passenger devices communicatively coupled to the at least one edge controller. In various embodiments, the one or more portable passenger devices are each configured with a user interface (UI) for interfacing with the at least one edge controller to submit at least one request to a crew member for an item of the plurality of items via the at least one edge controller.

In various embodiments, the at least one sensor comprises one or more of an optical sensor, a thermal sensor, an infrared sensor, an ultrasonic sensor, a pressure sensor, a weight sensor, a proximity sensor, an image sensor, a depth sensor, a multispectral sensor, a hyperspectral sensor, or a radio frequency sensor.

In various embodiments, the at least one edge controller is configured to operate at least one computational model to at least one of detect, identify, classify, or track items via the at least one sensor, wherein the at least one computational model comprises one or more of an artificial intelligence (AI) model, a machine learning (ML) model, a deep learning model, a neural network, a convolutional neural network, a computer vision algorithm, an object detection algorithm, an object recognition algorithm, a classification algorithm, or a regression algorithm.

In various embodiments, the perception based virtual galley management system further includes a master galley controller communicatively coupled to the at least one edge controller. In various embodiments, the master galley controller is configured with a digital manifest, the digital manifest including a list of unique items in the galley of the aircraft, quantities of each of the unique items, and locations of the unique items within each of the set of standard units.

In various embodiments, the master galley controller is configured to: check each item of the plurality of items against the digital manifest; and, responsive to the item failing to be on the digital manifest, add the item to the digital manifest.

In various embodiments, the perception based virtual galley management system further includes a plurality of galleys within the aircraft. In various embodiments, the master galley controller is configured to track the locations of the plurality of items within each standard unit in each of the plurality of galleys within the aircraft. In various embodiments, the master galley controller is configured to, responsive to an optimal placement or retrieval request for at least one of placement or retrieval of a unique item, look up the item in the digital manifest and return a location for the at least one of placement or retrieval of the unique item.

Also disclosed herein is an aircraft including a galley and a perception based virtual galley management system. The perception based virtual galley management system includes at least one edge controller, at least one leaf controller communicatively coupled to the at least one edge controller, and at least one sensor communicatively coupled to the at least one leaf controller. The at least one edge controller is configured to receive and process sensor data from the at least one sensor, via the at least one leaf controller, to track a plurality of items as they move in to or out of a standard unit within a galley of an aircraft.

In various embodiments, the perception based virtual galley management system further includes one or more digital panels, the one or more digital panels communicatively coupled to the at least one edge controller. In various embodiments, the one or more digital panels are each configured with a user interface (UI) for interfacing with the at least one edge controller to perform operations associated with the plurality of items within the galley.

In various embodiments, the perception based virtual galley management system further includes a set of standard units and a set of indicator lights. In various embodiments, the standard unit is one of the set of standard units. In various embodiments, each indicator light in the set of standard units associated with a respective standard unit in the set of standard units. In various embodiments, responsive to a request from a crew member via one of the one or more digital panels to locate an item of the plurality of items in one of the set of standard units, the at least one edge controller is configured to identify the standard unit including the item via the indicator light associated with the standard unit.

In various embodiments, the perception based virtual galley management system further includes one or more portable crew devices, the one or more portable crew devices communicatively coupled to the at least one edge controller. In various embodiments, the one or more portable crew devices are each configured with a user interface (UI) for interfacing with the at least one edge controller to perform operations associated with the plurality of items within the galley.

In various embodiments, the perception based virtual galley management system further includes one or more portable passenger devices. In various embodiments, the one or more portable passenger devices communicatively coupled to the at least one edge controller. In various embodiments, the one or more portable passenger devices are each configured with a user interface (UI) for interfacing with the at least one edge controller to submit at least one request to a crew member for an item of the plurality of items via the at least one edge controller.

In various embodiments, the at least one sensor comprises one or more of an optical sensor, a thermal sensor, an infrared sensor, an ultrasonic sensor, a pressure sensor, a weight sensor, a proximity sensor, an image sensor, a depth sensor, a multispectral sensor, a hyperspectral sensor, or a radio frequency sensor.

In various embodiments, the at least one edge controller is configured to operate at least one computational model to at least one of detect, identify, classify, or track items via the at least one sensor, wherein the at least one computational model comprises one or more of an artificial intelligence (AI) model, a machine learning (ML) model, a deep learning model, a neural network, a convolutional neural network, a computer vision algorithm, an object detection algorithm, an object recognition algorithm, a classification algorithm, or a regression algorithm.

In various embodiments, the perception based virtual galley management system further includes a master galley controller communicatively coupled to the at least one edge controller. In various embodiments, the master galley controller is configured with a digital manifest, the digital manifest including a list of unique items in the galley of the aircraft, quantities of each of the unique items, and locations of the unique items within each of the set of standard units.

In various embodiments, the master galley controller is configured to: check each item of the plurality of items against the digital manifest; and, responsive to the item failing to be on the digital manifest, add the item to the digital manifest.

In various embodiments, the perception based virtual galley management system further includes a plurality of galleys within the aircraft. In various embodiments, the master galley controller is configured to track the locations of the plurality of items within each standard unit in each of the plurality of galleys within the aircraft. In various embodiments, the master galley controller is configured to, responsive to an optimal placement or retrieval request for at least one of placement or retrieval of a unique item, look up the item in the digital manifest and return a location for the at least one of placement or retrieval of the unique item.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a layout of a typical larger-bodied aircraft, in accordance with various embodiments.

FIG. 2 illustrates a physical architecture of a perception based virtual galley management system, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As stated previously, one or more galleys that are located at different locations in the aircraft, e.g., in the area between the cockpit and the first row or passenger seats, at the back of the aircraft behind the last row of passenger seats or, for large aircraft, at various locations between aisles/rows of seats, store food and beverages on the aircraft. Food and beverages are typically stored in galley cabinets and galley carts, which are stowed in galley compartments and may be removed by the crew to provide passenger service.

Typically, aircraft galleys may be chaotic and stressful places during pre-boarding flight checks and during meal service times. Typical issues experienced by crew members during such times include, but are not limited to consistently maintaining service quality and speed while meeting passengers' evolving expectations, difficulty locating correct inventory quickly, reorganization of galley workspace to support multiple meal services; high volume multitasking; labor intensity of premium meal preparation; and/or health monitoring of galley inserts. Additionally, crew members typically have a high reported incident of workplace injuries associated with moving heavy containers over their heads while searching for items and reorganizing.

Various systems implemented to track inventory on aircrafts focus on Radio-Frequency Identification (RFID) and other similar technologies. However, the issue with such technologies is that an RFID tag needs to be integrated into each packaged item or group of items and sensors have to located with multiple locations within each galley. The two issues with this solution are the added cost to the suppliers to install RFID tags in a small percent of their packaging and standard units are constantly being exchanged with different aircraft and airlines by catering companies. This makes airlines hesitant to invest technology integrated into standard units. Additionally, any solution should manage inventory across all galleys within the aircraft so that the system knows the inventory of the front galley(s), the inventory of the rear galley(s), as well as any intermediate galley(s), to be able to inform the crew of requested items.

The illustrative embodiments provide a perception based virtual galley management system that provides inventory tracking and crew task management at an individual galley and aircraft level. In various embodiments, the perception based virtual galley management system utilizes one or more sensors, including but not limited to optical sensors, thermal sensors, infrared sensors, ultrasonic sensors, pressure sensors, weight sensors, proximity sensors, image sensors, depth sensors, multispectral sensors, hyperspectral sensors, radio frequency sensors, or any combination thereof, in conjunction with artificial intelligence (AI) and/or machine learning (ML) models to track inventory items within each of the galleys. The one or more sensors may be configured to detect electromagnetic radiation, temperature variations, physical presence, weight changes, distance measurements, or other physical properties indicative of item presence, movement, or characteristics. In various embodiments, the perception based virtual galley management system may track items as they move from one standard unit, i.e., from a loading vehicle into a galley cabinet or galley cart, from a galley cabinet to a galley cart, from one galley cart to another galley cart, or from a galley cart to a galley cabinet, among others. Additionally, in various embodiments, the perception based virtual galley management system may track items as they are loaded into and removed from a self-serve snack tray. In various embodiments, the perception based virtual galley management system may be configured with crew and passenger touch points that enable the crew and passengers to interface with the perception based virtual galley management system. In various embodiments, the sensors may also enable health monitoring of non-connected and conforming galley inserts by monitoring galley insert indicator lights or other status indicators. In various embodiments, the perception based virtual galley management system may also be configured to send automated notifications of pending tasks to the crew members or ground personnel, such as coffee is done, latch left unlocked, or items out of stock, among others.

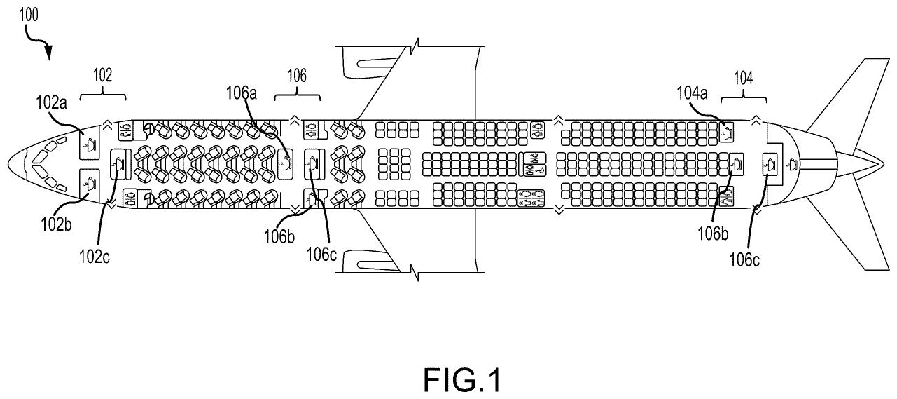

Referring now to FIG. 1, a layout of a typical larger-bodied aircraft, such as an A350, is illustrated, in accordance with various embodiments. In various embodiments, the aircraft 100 includes three galley zones, front galley zone 102, rear galley zone 104, and intermediate galley zone 106. In various embodiments, each of the front galley zone 102, the rear galley zone 104, and the intermediate galley zone 106 may have one or more galleys, i.e., galley 102a, 102b, and 102c associated with the front galley zone 102, galley 104a, 104b, and 104c associated with the rear galley zone 104, galley 106a, 106b, and 106c associated with the intermediate galley zone 106. In various embodiments, the perception based virtual galley management system is configured to digitally manage inventory and tasks for each of the galleys 102a, 102b, 102c, 104a, 104b, 104c, 106a, 106b, and 106c in the aircraft 100.

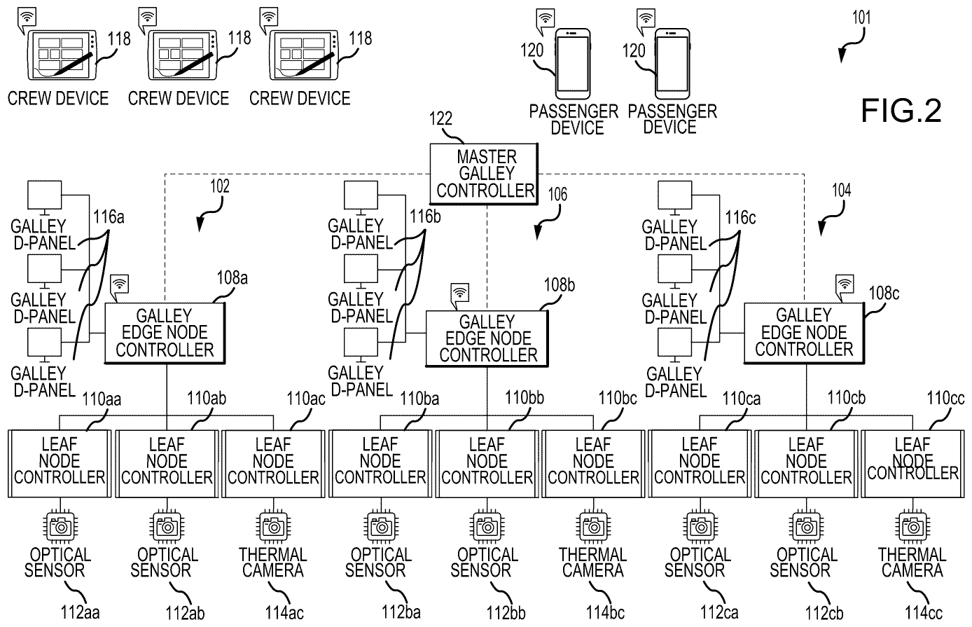

Referring now to FIG. 2, a physical architecture of a perception based virtual galley management system is illustrated, in accordance with various embodiments. In various embodiments, the perception based virtual galley management system 101 may be a distributed system with each galley zone 102, 104, and 106 having an edge node controller 108a, 108b, or 108c. In various embodiments, each edge node controller 108a, 108b, and 108c, may have and be communicatively coupled, i.e., either wired or wirelessly, to one or more leaf node controllers 110aa, 110ab, and 110ac, 110ba, 110bb, 110bc, 110ca, 110cb, and 110cc, respectively. In various embodiments, wireless communications operate within frequency bands approved for aircraft cabin use for radio frequency susceptibility and emissions, thereby ensuring no or reduced interference with aircraft avionics, navigation systems, and/or communication equipment.

In various embodiments, the one or more leaf node controllers 110aa, 110ab, and 110ac, 110ba, 110bb, 110bc, 110ca, 110cb, and 110cc, the edge node controllers 108a, 108b, and 108c, and the master galley controller 122, described in detail hereafter, may comprise one or more processors configured to implement various logical operations in response to execution of instructions, for example, instructions stored on a non-transitory, tangible, computer-readable medium. The one or more processors can be a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. In various embodiments, the one or more leaf node controllers 110aa, 110ab, and 110ac, 110ba, 110bb, 110bc, 110ca, 110cb, and 110cc, the edge node controllers 108a, 108b, and 108c, and the master galley controller 122 each comprise dedicated input/output interfaces configured to provide inventory tracking and crew task management at an individual galley and aircraft level. In various embodiments, the one or more leaf node controllers 110aa, 110ab, and 110ac, 110ba, 110bb, 110bc, 110ca, 110cb, and 110cc, the edge node controllers 108a, 108b, and 108c, and the master galley controller 122 may further comprise memory to store data, executable instructions, system program instructions, and/or controller instructions to implement the control logic of the one or more leaf node controllers 110aa, 110ab, and 110ac, 110ba, 110bb, 110bc, 110ca, 110cb, and 110cc, the edge node controllers 108a, 108b, and 108c, and the master galley controller 122. In various embodiments, the memory comprises volatile memory for storing real-time sensor data and non-volatile memory for storing control parameters, calibration data, and operational thresholds.

System program instructions and/or controller instructions may be loaded onto a non-transitory, tangible computer-readable medium having instructions stored thereon that, in response to execution by the one or more leaf node controllers 110aa, 110ab, and 110ac, 110ba, 110bb, 110bc, 110ca, 110cb, and 110cc, the edge node controllers 108a, 108b, and 108c, and the master galley controller 122, cause the one or more leaf node controllers 110aa, 110ab, and 110ac, 110ba, 110bb, 110bc, 110ca, 110cb, and 110cc, the edge node controllers 108a, 108b, and 108c, and the master galley controller 122 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In various embodiments, one or more sensors may be communicatively coupled to each one of the one or more leaf node controllers 110aa, 110ab, 110ac, 110ba, 110bb, 110bc, 110ca, 110cb, and 110cc through any suitable communication interface, including wired connections, wireless connections, or hybrid configurations. The one or more sensors may include, without limitation, optical sensors, thermal sensors, infrared sensors, ultrasonic sensors, pressure sensors, weight sensors, proximity sensors, image sensors, depth sensors, multispectral sensors, hyperspectral sensors, radio frequency sensors, or any combination thereof. In various embodiments, the communication interface may utilize any suitable protocol including, but not limited to, digital interfaces, analog interfaces, serial communication protocols, parallel communication protocols, I2C, SPI, UART, CAN bus, USB, Ethernet, or proprietary protocols. In various embodiments, wireless communications may operate within any frequency bands approved for aircraft cabin use for radio frequency susceptibility and emissions, including but not limited to Wi-Fi, Bluetooth, Zigbee, IEEE 802.15.4, IEEE 802.11 variants, or other wireless standards, thereby ensuring no or reduced interference with aircraft avionics, navigation systems, and/or communication equipment. Accordingly, in various embodiments, sensors 112aa, 112ab, 114ac, 112ba, 112bb, 114bc, 112ca, 112cb, and 114cc are communicatively coupled to their respective leaf node controllers 110aa, 110ab, 110ac, 110ba, 110bb, 110bc, 110ca, 110cb, and 110cc through one or more communication interfaces.

While in the illustrative embodiments only three leaf nodes and a limited number of sensors are illustrated, the illustrative embodiments are not limited to this configuration. That is, in the illustrative embodiments, any number of leaf nodes and any combination of sensors of any type may be communicatively coupled to one or more of the edge node controller 108a, 108b, and/or 108c, without departing from the spirit and scope of the invention. The sensors may be positioned at any location within or adjacent to the galleys, including within standard units, on doors, on ceilings, on walls, on countertops, within cabinets, on carts, or at galley entrances or exits, to provide optimal coverage and detection capabilities. In various embodiments, the one or more leaf node controllers 110aa, 110ab, 110ac, 110ba, 110bb, 110bc, 110ca, 110cb, and 110cc, and the sensors 112aa, 112ab, 114ac, 112ba, 112bb, 114bc, 112ca, 112cb, and 114cc may be configured to capture data from each of the galleys 102a, 102b, 102c, 104a, 104b, 104c, 106a, 106b, and 106c in the aircraft 100.

Accordingly, in various embodiments, the one or more leaf node controllers 110aa, 110ab, 110ac, 110ba, 110bb, 110bc, 110ca, 110cb, and 110cc are configured to receive, process, and analyze real-time sensor data and/or historical sensor data from the sensors 112aa, 112ab, 114ac, 112ba, 112bb, 114bc, 112ca, 112cb, and 114cc in real time using any suitable data processing techniques, including signal processing, image processing, pattern recognition, statistical analysis, filtering, transformation, aggregation, fusion, or combinations thereof, to track items as they move in to or out of one standard unit, i.e., from a loading vehicle into a standard unit or galley cart, from a standard unit to a galley cart, from one galley cart to another galley cart, or from a galley cart to a standard unit, from one standard unit to another standard unit, among others. The data processing may be performed locally at the leaf node controllers 110aa, 110ab, 110ac, 110ba, 110bb, 110bc, 110ca, 110cb, and 110cc, at the edge node controllers 108a, 108b, and 108c, at the master galley controller 122, or distributed across multiple controllers. Additionally, in various embodiments, the perception based virtual galley management system 101 may track items as they are loaded into and removed from a self-serve snack tray.

In various embodiments, one or more digital panels 116a, 116b, and 116c may be located within each of the front galley zone 102, the rear galley zone 104, and the intermediate galley zone 106. In various embodiments, the front galley zone 102 may have one or more digital panels 116a, the rear galley zone 104 may have one or more digital panels 116b, and the intermediate galley zone 106 may have one or more digital panels 116c. In various embodiments, each of the one or more digital panels 116a, 116b, and 116c may be communicatively coupled, i.e., either wired or wirelessly, to a respective one of edge node controller 108a, 108b, and 108c. Again, in various embodiments, wireless communications operate within frequency bands approved for aircraft cabin use for radio frequency susceptibility and emissions, thereby ensuring no or reduced interference with aircraft avionics, navigation systems, and/or communication equipment. In various embodiments, each of the one or more digital panels 116a, 116b, and 116c provide a user interface (UI) for the crew members to interface with the perception based virtual galley management system 101, such as perform various operations, i.e., load items into a standard unit or identify a standard unit storing a particular item, among others.

Additionally, in various embodiments, each of the edge node controllers 108a, 108b, and 108c may be configured to communicate with one or more portable crew devices 118 and/or portable passenger devices 120. In that regard, in various embodiments, one or more of the portable crew devices 118 and/or the portable passenger devices 120 may be communicatively coupled, i.e., either wired or wirelessly, to one or more of the edge node controllers 108a, 108b, and 108c. Again, in various embodiments, wireless communications operate within frequency bands approved for aircraft cabin use for radio frequency susceptibility and emissions, thereby ensuring no or reduced interference with aircraft avionics, navigation systems, and/or communication equipment. In various embodiments, each of the one or more of the portable crew devices 118 and/or the portable passenger devices 120 provide a user interface (UI) for the crew members to interface with the perception based virtual galley management system 101, such as perform various operations, i.e., load items into a standard unit or identify a standard unit storing a particular item, among others. In that regard, each of the one or more of the portable crew devices 118 and/or the portable passenger devices 120 are configured to receive requests and submit orders. In various embodiments, each of the portable crew devices 118 and/or the portable passenger devices 120 are configured to communicatively couple, i.e., either wired or wirelessly, to one or more of the edge node controllers 108a, 108b, and 108c using Wi-Fi within the aircraft 100. In various embodiments, each of the portable crew devices 118 and/or the portable passenger devices 120 are configured to only communicatively couple to the devices of the perception based virtual galley management system 101 within the aircraft 100.

In various embodiments, each of the edge node controller 108a, 108b, and 108c, and/or the one or more leaf node controllers are configured to operate one or more artificial intelligence (AI) models, machine learning (ML) models, deep learning models, neural networks, convolutional neural networks, computer vision algorithms, object detection algorithms, object recognition algorithms, classification algorithms, regression algorithms, or other computational models in order to detect, identify, classify, or track items via the sensors 112aa, 112ab, 114ac, 112ba, 112bb, 114bc, 112ca, 112cb, and 114cc. The AI/ML models may be trained, updated, or refined based on collected data, and may operate on raw sensor data, preprocessed sensor data, or features extracted from sensor data. In various embodiments, each of the one or more edge node controllers 108a, 108b, and 108c, and/or the one or more leaf node controllers is configured to analyze the data from the one or more AI and/or ML models using one or more fusion modules, data integration techniques, or aggregation methods to determine one or more of activities being performed with the detected object, a state of the detected object, a location of the detected object, a quantity of detected objects, or characteristics of detected objects. In various embodiments, responsive to a crew member utilizing one of the one or more digital panels 116a, 116b, and 116c to find a particular item, the perception based virtual galley management system 101 may be configured with indicator lights or other signaling devices associated with each standard unit at each galley and the one or more edge node controllers 108a, 108b, and 108c may be configured to identify the standard unit including the item via the associated indicator light or signaling device as well as configured to warn the crew member that the standard unit may contain heavy items.

In various embodiments, each of the edge node controllers 108a, 108b, and 108c are configured to communicatively couple, i.e., either wired or wirelessly, to a master galley controller 122. Again, in various embodiments, wireless communications operate within frequency bands approved for aircraft cabin use for radio frequency susceptibility and emissions, thereby ensuring no or reduced interference with aircraft avionics, navigation systems, and/or communication equipment. In various embodiments, any communication between any of the devices in the perception based virtual galley management system 101, other than the portable crew devices 118 and the portable passenger devices 120, may be by wired or wireless means. In various embodiments, the wireless communication may be on a virtual private network using IEEE 802.15.4 wireless protocol, although other wireless protocols may be utilized.

In various embodiments, the master galley controller 122 is configured to prioritize requests from each of the galleys 102a, 102b, 102c, 104a, 104b, 104c, 106a, 106b, and 106c and communicate with an intended one of the one or more digital panels 116a, 116b, and 116c, the portable crew devices 118, and/or the portable passenger devices 120. In various embodiments, the master galley controller 122 is configured to manage a digital manifest to ensure a single source of inventoried items and their locations within the aircraft 100. In various embodiments, rather than the master galley controller 122 being a standalone device, one of the edge node controllers 108a, 108b, or 108c may be configured as the master galley controller.

In various embodiments, the master galley controller 122 may be configured to locally or remotely receive the digital manifest or, alternatively, generate the digital manifest from a scanned paper manifest. In various embodiments, the digital manifest includes a list of unique items in each of the galleys 102a, 102b, 102c, 104a, 104b, 104c, 106a, 106b, and 106c, quantities (state) of each of the unique items, and locations of the unique items within each of the galleys 102a, 102b, 102c, 104a, 104b, 104c, 106a, 106b, and 106c, i.e. a standard unit location. A standard unit (SU) is the technical term used in the airline industry to describe the storage bins in the galley. In various embodiments, as new items are loaded into a standard unit, the perception based virtual galley management system 101 is configured to detect and identify the item and the standard unit via one or more of the sensors 112aa, 112ab, 114ac, 112ba, 112bb, 114bc, 112ca, 112cb, and 114cc using any suitable detection method including optical character recognition, barcode reading, QR code reading, RFID detection, image recognition, thermal signature analysis, weight measurement, or other sensing modalities, and the master galley controller 122 is configured to check the item against the digital manifest. In various embodiments, responsive to an item failing to be on the digital manifest, the master galley controller 122 may be configured to add the item to the digital manifest. Accordingly, the perception based virtual galley management system 101 may be configured to track items as they are moved between standard units within a galley or between galleys and send new information to the master galley controller 122 to update the digital manifest.

In various embodiments, the master galley controller 122 may be configured to provide optimal placement recommendations or retrieval of items within standard units based on contents and service needs, which provides a standard across all similar aircrafts. In various embodiments, the master galley controller 122 may provide this information to the crew members via one or more of the one or more digital panels 116a, 116b, and 116c, the portable crew devices 118, and/or indicator lights. In various embodiments, the information may be displayed on a user interface of the one or more digital panels 116a, 116b, and 116c and/or the portable crew devices 118 or may be broadcast as digital voice commands via the one or more digital panels 116a, 116b, and 116c and/or the portable crew devices 118. In various embodiments, each of the one or more digital panels 116a, 116b, and 116c is communicatively coupled, i.e., either wired or wirelessly, a respective one of the one of the edge node controller 108a, 108b, or 108c. In various embodiments, inventory requests from one of the one or more digital panels 116a, 116b, and 116c are sent to the master galley controller 122. In various embodiments, responsive to an optimal placement or retrieval request for placement of an item, the master galley controller 122 is configured to look up the item and return the location for optimal placement or retrieval to the requesting one of the one or more digital panels 116a, 116b, and 116c.

In various embodiments, perception based virtual galley management system 101 may be configured to notify and track tasks sent by the master galley controller 122 to crew members to take actions such as coffee is done, latch left unlocked, or items out of stock, among others. In various embodiments, the portable crew devices 118 may be configured to send and receive the same information as the one or more digital panels 116a, 116b, and 116c, when crew members are away from the galley. In various embodiments, crew members may interact with the master galley controller 122 using verbal triggers to find items and have tasks read to them while they are preparing meal service. In various embodiments, the tasks may include one or more of tracking objects as they move from one standard unit to another ensuring the locations of items is always current, which is important because galley service may be chaotic and crew members may not always return items back in the correct standard unit. In various embodiments, the tasks may include tracking inventory items in the self-serve snack trays and providing a task to the flight crew when a rack or bin needs to be refilled. In various embodiments, the tasks may include tracking requests from passengers, other crew members, and applications on the one or more digital panels 116a, 116b, and 116c to keep accurate inventory of items in standard units. In various embodiments, tasks may be automatically added to the system from seats with predictive services enabled. In various embodiments, tasks may enhance safety by including notifications to crew members when latches are not latched or when doors are left open, among others.

In various embodiments, the perception based virtual galley management system 101 may perform prognostic health monitoring of the galley inserts by observing the changes in galley inserts, such as their indicator lights. In various embodiments, the perception based virtual galley management system 101 may record the number of on/off cycles and their time duration, so as to predict remaining cycle life. In various embodiments, the perception based virtual galley management system 101 may also detect an inoperable state of a galley insert by the color change in the indicator light and create a maintenance request for the crew to approve and send to ground maintenance. In various embodiments, the crew may utilize the portable crew devices 118 or the one or more digital panels 116a, 116b, and 116c to monitor the status of the galley inserts for any galley from anywhere on the aircraft 100. In various embodiments, the perception based virtual galley management system 101 may also notify a crew member when a galley insert cycle is complete, which allows the crew member to, for example, start another coffee brew cycle and go attend to other tasks and know when the coffee is complete without walking back to the galley, which enable more efficient time management.

Accordingly, in various embodiments, the perception based virtual galley management system provide the crew members an efficient means for searching for items within the galley, which saves time when preparing meal service. In various embodiments, the perception based virtual galley management system improves organization of items within the standard units to minimize movements of crew members during meal service, thereby improving efficiency. In various embodiments, the perception based virtual galley management system reduces the number of times the crew open standard units as they look for items, which may reduce their risk to repetitive injuries. In various embodiments, the perception based virtual galley management system monitors galley inserts thereby enabling proactive health monitoring of the galley inserts. In various embodiments, the perception based virtual galley management system may provide safety related notifications to the crew to prevent accidents or injury. In various embodiments, the perception based virtual galley management system may save data generated from the system and send the data to enable airlines to better optimize services and inventory to reduce operating costs.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A perception based virtual galley management system, comprising:
at least one edge controller;
at least one leaf controller communicatively coupled to the at least one edge controller; and
at least one sensor communicatively coupled to the at least one leaf controller,
wherein the at least one edge controller is configured to receive and process sensor data from the at least one sensor, via the at least one leaf controller, to track a plurality of items as they move in to or out of a standard unit within a galley of an aircraft.

2. The perception based virtual galley management system of claim 1, further comprising:
one or more digital panels, the one or more digital panels communicatively coupled to the at least one edge controller, wherein the one or more digital panels are each configured with a user interface (UI) for interfacing with the at least one edge controller to perform operations associated with the plurality of items within the galley.

3. The perception based virtual galley management system of claim 2, further comprising:
a set of standard units, wherein the standard unit is one of the set of standard units; and
a set of indicator lights, each indicator light in the set of standard units associated with a respective standard unit in the set of standard units,
wherein, responsive to a request from a crew member via one of the one or more digital panels to locate an item of the plurality of items in one of the set of standard units, the at least one edge controller is configured to identify the standard unit including the item via the indicator light associated with the standard unit.

4. The perception based virtual galley management system of claim 1, further comprising:
one or more portable crew devices, the one or more portable crew devices communicatively coupled to the at least one edge controller, wherein the one or more portable crew devices are each configured with a user interface (UI) for interfacing with the at least one edge controller to perform operations associated with the plurality of items within the galley.

5. The perception based virtual galley management system of claim 1, further comprising:
one or more portable passenger devices, the one or more portable passenger devices communicatively coupled to the at least one edge controller, wherein the one or more portable passenger devices are each configured with a user interface (UI) for interfacing with the at least one edge controller to submit at least one request to a crew member for an item of the plurality of items via the at least one edge controller.

6. The perception based virtual galley management system of claim 1, wherein the at least one sensor comprises one or more of an optical sensor, a thermal sensor, an infrared sensor, an ultrasonic sensor, a pressure sensor, a weight sensor, a proximity sensor, an image sensor, a depth sensor, a multispectral sensor, a hyperspectral sensor, or a radio frequency sensor.

7. The perception based virtual galley management system of claim 1, wherein the at least one edge controller is configured to operate at least one computational model to at least one of detect, identify, classify, or track items via the at least one sensor, wherein the at least one computational model comprises one or more of an artificial intelligence (AI) model, a machine learning (ML) model, a deep learning model, a neural network, a convolutional neural network, a computer vision algorithm, an object detection algorithm, an object recognition algorithm, a classification algorithm, or a regression algorithm.

8. The perception based virtual galley management system of claim 3, further comprising:
a master galley controller communicatively coupled to the at least one edge controller,
wherein the master galley controller is configured with a digital manifest, the digital manifest including a list of unique items in the galley of the aircraft, quantities of each of the unique items, and locations of the unique items within each of the set of standard units.

9. The perception based virtual galley management system of claim 8, wherein the master galley controller is configured to:
check each item of the plurality of items against the digital manifest; and
responsive to the item failing to be on the digital manifest, add the item to the digital manifest.

10. The perception based virtual galley management system of claim 8, further comprising:
a plurality of galleys within the aircraft,
wherein the master galley controller is configured to track the locations of the plurality of items within each standard unit in each of the plurality of galleys within the aircraft, and
wherein the master galley controller is configured to, responsive to an optimal placement or retrieval request for at least one of placement or retrieval of a unique item, look up the item in the digital manifest and return a location for the at least one of placement or retrieval of the unique item.

11. An aircraft comprising:
a galley; and
a perception based virtual galley management system, comprising:
at least one edge controller;
at least one leaf controller communicatively coupled to the at least one edge controller; and
at least one sensor communicatively coupled to the at least one leaf controller,
wherein the at least one edge controller is configured to receive and process sensor data from the at least one sensor, via the at least one leaf controller, to track a plurality of items as they move in to or out of a standard unit within the galley of the aircraft.

12. The aircraft of claim 11, further comprising:
one or more digital panels, the one or more digital panels communicatively coupled to the at least one edge controller, wherein the one or more digital panels are each configured with a user interface (UI) for interfacing with the at least one edge controller to perform operations associated with the plurality of items within the galley.

13. The aircraft of claim 12, further comprising:
a set of standard units, wherein the standard unit is one of the set of standard units; and
a set of indicator lights, each indicator light in the set of standard units associated with a respective standard unit in the set of standard units,
wherein, responsive to a request from a crew member via one of the one or more digital panels to locate an item of the plurality of items in one of the set of standard units, the at least one edge controller is configured to identify the standard unit including the item via the indicator light associated with the standard unit.

14. The aircraft of claim 11, further comprising:
one or more portable crew devices, the one or more portable crew devices communicatively coupled to the at least one edge controller, wherein the one or more portable crew devices are each configured with a user interface (UI) for interfacing with the at least one edge controller to perform operations associated with the plurality of items within the galley.

15. The aircraft of claim 11, further comprising:
one or more portable passenger devices, the one or more portable passenger devices communicatively coupled to the at least one edge controller, wherein the one or more portable passenger devices are each configured with a user interface (UI) for interfacing with the at least one edge controller to submit at least one request to a crew member for an item of the plurality of items via the at least one edge controller.

16. The aircraft of claim 11, wherein the at least one sensor comprises one or more of an optical sensor, a thermal sensor, an infrared sensor, an ultrasonic sensor, a pressure sensor, a weight sensor, a proximity sensor, an image sensor, a depth sensor, a multispectral sensor, a hyperspectral sensor, or a radio frequency sensor.

17. The aircraft of claim 11, wherein the at least one edge controller is configured to operate at least one computational model to detect, identify, classify, or track items via the at least one sensor, wherein the at least one computational model comprises one or more of an artificial intelligence (AI) model, a machine learning (ML) model, a deep learning model, a neural network, a convolutional neural network, a computer vision algorithm, an object detection algorithm, an object recognition algorithm, a classification algorithm, or a regression algorithm.

18. The aircraft of claim 13, further comprising:
a master galley controller communicatively coupled to the at least one edge controller,
wherein the master galley controller is configured with a digital manifest, the digital manifest including a list of unique items in the galley of the aircraft, quantities of each of the unique items, and locations of the unique items within each of the set of standard units.

19. The aircraft of claim 18, wherein the master galley controller is configured to:
check each item of the plurality of items against the digital manifest; and
responsive to the item failing to be on the digital manifest, add the item to the digital manifest.

20. The aircraft of claim 18, further comprising:
a plurality of galleys within the aircraft,
wherein the master galley controller is configured to track the locations of the plurality of items within each standard unit in each of the plurality of galleys within the aircraft, and
wherein the master galley controller is configured to, responsive to an optimal placement or retrieval request for at least one of placement or retrieval of a unique item, look up the item in the digital manifest and return a location for the at least one of placement or retrieval of the unique item.
